(19) United States
(12) Patent Application Publication
(10) Pub. No.: US 2019/0293238 A1
(43) Pub. Date: Sep. 26, 2019

(54) System and Method for Transfering Liquid Argon to Bulk Transport Tanks

(71) Applicant: Ralph Johanson, Davenport, IA (US)

(72) Inventor: Ralph Johanson, Davenport, IA (US)

(21) Appl. No.: 15/934,509

(22) Filed: Mar. 23, 2018

(51) Int. Cl. F17C 7/02

(52) U.S. Cl. CPC F17C 7/02; F17C 2221/016; F17C 2223/013; F17C 2223/033; F17C 2223/035; F17C 2260/03; F17C 2225/031; F17C 2225/033; F17C 2227/0135; F17C 2227/0341; F17C 2225/013

(57) ABSTRACT

A system and method is provided for transferring liquid argon from a bulk storage tank to a transport tank in which liquid argon is pumped through a tube arrangement within a heat exchanger and the tube arrangement is contacted by liquid nitrogen at a temperature less than the temperature of the liquid argon so that heat transfers from the liquid argon to the liquid nitrogen, thereby reducing the temperature, density and pressure of the liquid nitrogen prior to exiting the heat exchanger.

### BACKGROUND

This disclosure relates to systems for transporting and delivering cryogenic gases, such as argon, and particularly to a system and method for transferring the argon gas in a liquefied state from bulk storage tanks to transport tanks.

Most cryogenic gases, such as argon, are used in a gaseous state and therefore sold in the gaseous state. Transporting such cryogenic gases in a gaseous state has been known for many years. However, the total volume of cryogenic gas which can be transported in a gaseous state is considerably less than can be transported in a liquid state. Argon has an expansion ratio of 1 to 840, which means that a unit weight of gaseous argon has a volume about 840 times greater than the same unit weight of liquid argon.

Therefore, in order to maximize the quantity of gas that can be transported, the gas is converted to its liquefied state and introduced into a transportation tank. Typically, the gas is maintained in a liquid state in bulk storage tanks and then transferred from those bulk tanks to the transportation tank. During the transfer of argon, as much as 30% of the liquefied argon is lost due to the pressure drop between bulk tank and transport tank that is necessary to transfer the liquid argon. The pressure drop is further due to federal transport regulations that limit the pressure for transportation of the liquid argon, as opposed to the much higher pressure permitted for bulk storage of the liquefied gas. For instance, liquid argon is typically stored at a pressure of about 100 psig, whereas the transport pressure is typically about 22-25 psig. This significant pressure drop causes a significant amount of the liquid argon to change state and evaporate, and the gaseous argon is necessarily vented to atmosphere as part of the liquid gas transfer system.

There is a significant unmet need for a system and method for bulk transfer of liquid argon, and other cryogenic gases, which greatly minimizes the losses incumbent with the current methods of transfer.

### SUMMARY OF THE DISCLOSURE

A system and method is provided for transferring liquid argon from a bulk storage tank to a transport tank in which liquid argon is transferred at a first temperature and a first pressure through a tubing arrangement within a housing. The tubing arrangement is contacted by liquid nitrogen within the housing, the liquid nitrogen being at a second temperature within the housing that is lower than the first temperature so that heat energy is transferred from the liquid argon to the liquid nitrogen. This heat transfer reduces the temperature and pressure of the liquid argon within the tubing arrangement for discharge to the transport tank. The heat transfer also causes the liquid nitrogen to change to a gaseous state, so that the gaseous nitrogen is vented from the housing. In one aspect, the first temperature of the liquid argon is −256 and the second temperature of the liquid nitrogen is −280. In a further aspect, the first pressure of the liquid argon is between 50-250 psig and the reduced pressure of the liquid argon is between 5-50 psig or less.

In one embodiment, the tubing arrangement for the liquid argon is a spiral tube from an inlet at the top of the housing to an outlet at the bottom of the housing. In one embodiment, the liquid nitrogen is directed into the housing and onto the spiral tube by a spray nozzle at the top of the housing. In another embodiment, the liquid nitrogen is directed through a second spiral tubing arrangement concentrically disposed adjacent the tubing arrangement for the liquid argon. A series of openings in the liquid nitrogen tube directs the liquid nitrogen directly onto the tubing arrangement for the liquid argon.

In a further embodiment, the tubing arrangement for the liquid argon includes a plurality of U-shaped tubes. The tubes are configured for generally nested arrangement within a tubular housing. Liquid nitrogen is introduced into the tubular housing to directly contact each of the plurality of U-shaped tubes to effect the heat transfer between the liquid argon and the liquid nitrogen.

### DESCRIPTION OF THE DRAWINGS

FIG. 1 is a diagram of a system for transferring liquid argon from a bulk storage tank to a transport tank according to one embodiment of the present disclosure.

FIG. 2 is an enlarged view of argon and nitrogen tubing arrangements in a heat exchanger of the system shown in FIG. 1

FIG. 3 is a side view of a heat exchanger according to another embodiment of the present disclosure.

FIG. 4 is a top view of the heat exchanger shown in FIG. 3.

FIG. 5 is a cross-sectional view of the heat exchanger shown in FIG. 3.

FIG. 6 is a side cut-away view of the argon tubing arrangement for the heat exchanger shown in FIG. 3.

FIG. 7a, 7b are top views of baffles disposed within the heat exchanger shown in FIG. 3.

FIG. 8 is an enlarged cut-away view of the mounting flange of the heat exchanger shown in FIG. 3.

### DETAILED DESCRIPTION OF THE INVENTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles disclosed herein as would normally occur to one skilled in the art to which this disclosure pertains

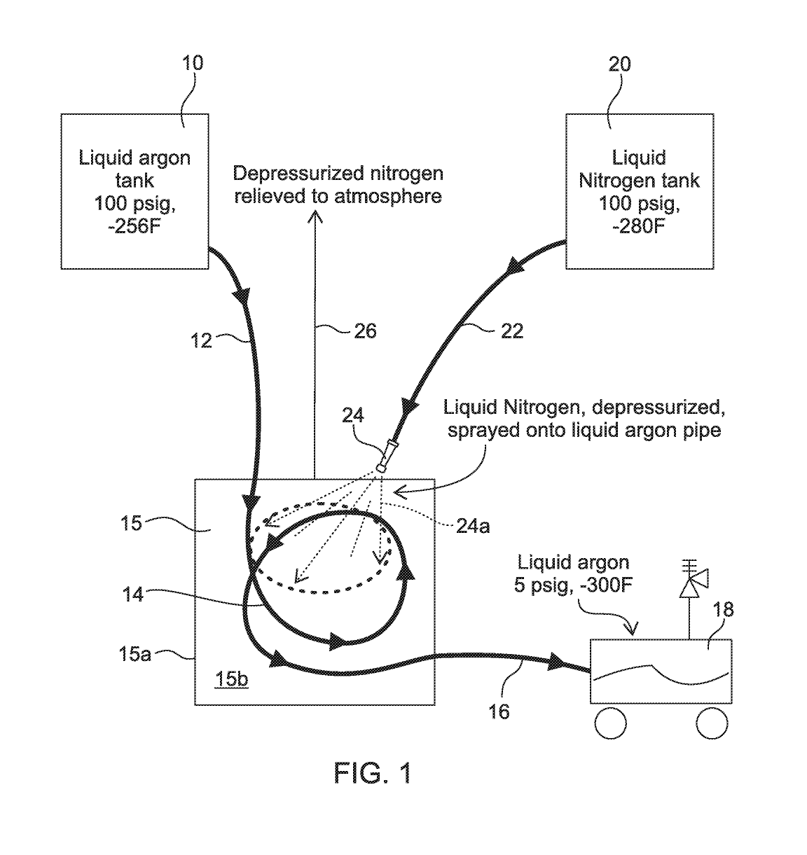

One embodiment of the present system is depicted schematically in FIG. 1. A supply of liquid argon is stored within a bulk tank 10 at 100 psig and a temperature of −256° F. The bulk tank is constructed in a conventional manner to safely hold the liquefied argon under pressure, and may be insulated in a conventional manner. Liquid argon is supplied by tube 12 to an internal pipes or tube arrangement 14 within a heat exchanger unit 15. The liquid argon exits the heat exchanger unit 15 through an outlet tube 16 that supplies the liquid argon to a DOT approved transport vehicle 18.

In one embodiment, the heat exchanger unit includes a housing 15a defining an interior volume 15b. The housing may be formed of any suitable material capable of maintaining the interior volume substantially sealed except at pre-defined inlets and outlet. The inlet tube 12 and outlet tube 16 can be connected to the heat exchanger 15 by appropriate fittings to maintain a leak-proof transfer of the liquid argon from the inlet tube 12 to the internal tube arrangement 14, and from the tube arrangement to the outlet tube 16.

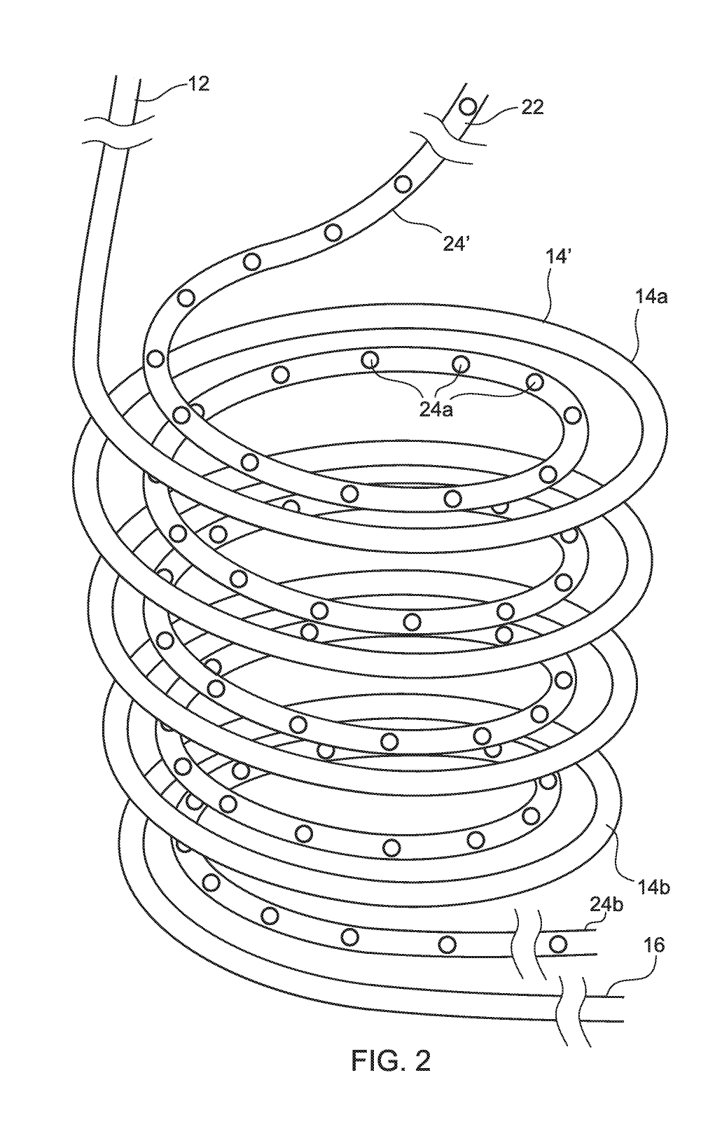

In one embodiment, the internal tube arrangement 14 includes a tube or pipe, such as a copper tube, that is wound within the interior volume 15b from the inlet tube 12 to the outlet tube 16, as illustrated in FIG. 2. The tube arrangement can thus include a number of turns, such as 20 turns, in the spiral configuration. The spiral configuration can start with the first loop 14a of the spiral having a diameter slightly less than the perimeter dimensions of the housing 15a. In one specific embodiment, the housing is a six foot cube, so the first loop 14a of the spiral tube arrangement 14 can have a diameter of about five feet. The diameter of each successive loop can decrease to the last loop 14b that is connected to the outlet tube 16, which can have a diameter of about one foot.

In one feature of the present disclosure, a liquid nitrogen tank 20 is connected to the heat exchanger 15 by an inlet tube 22. In one embodiment, the inlet tube 22 is connected to a spray nozzle 24 mounted within the housing 15a. The spray nozzle 24 is configured and arranged to direct a spray of liquid nitrogen across the internal tube arrangement 14 carrying the liquid argon. A vent 26 is provided to vent the nitrogen as it changes state from liquid to gas.

The liquid nitrogen in the tank 20 is maintained at a temperature and pressure that allows the liquid nitrogen to be at a temperature within the heat exchanger that is lower than the temperature of the liquid argon being transferred to the transport tank 18. Thus, in the present illustrated embodiment the liquid argon is stored at a temperature of −256° F. and warms slightly to a temperature of about −250° F. upon entering the heat exchanger 15. In this illustrated embodiment, the liquid nitrogen is stored at a temperature of −280° F. The liquid nitrogen is stored at a pressure of 100 psig so that as the nitrogen is depressurized upon exiting the nozzle 24 it will sufficiently cover the internal tube arrangement 14. As the nitrogen depressurizes its temperature decreases to about −320° F., which is significantly colder than the liquid argon flowing through the internal tube arrangement 14. This temperature differential results in heat transfer from the liquid argon to the liquid nitrogen sprayed onto the tube arrangement, thereby reducing the temperature of the liquid argon by about 20° F. Spraying the nitrogen onto the internal tube arrangement reduces the Leidenfrost effect, which helps maintain the heat transfer from the liquid argon to the liquid nitrogen.

In another embodiment, the spray nozzle 24 is replaced by a spiral tube, such as spiral tube 24′, which is concentrically disposed adjacent an internal spiral tube arrangement 14′ for the liquid argon, as shown in FIG. 2. The liquid nitrogen spiral tube includes a series of small holes 24a in the tube directed toward the adjacent spiral tube arrangement 14′ so that liquid nitrogen ejected from each hole is sprayed directly onto the argon tube 14. The end 24b of the tube can be capped. The sprayed nitrogen again acts to draw thermal energy from the argon flowing through the tube arrangement 14 to thereby lower the temperature of the liquid argon. The holes 24a can be limited to portions of the spiral tube 24′ that are in immediate proximity to portions of the argon tube arrangement 14, or can extend along substantially the entire length of the tube. In the illustrated embodiment, the liquid nitrogen spiral tube 24′ is concentrically wound with the liquid argon spiral tube 14′. In a specific embodiment, the liquid nitrogen tube 24′ is wound at a smaller diameter than the liquid argon tube 14′ so that the liquid nitrogen tube is generally radially inboard of the liquid argon tube. In this configuration, the openings 24a are arranged in the tube 24′ to direct the liquid nitrogen generally radially outward toward the liquid argon tube 14′. Alternatively, the liquid nitrogen tube can be wound at a larger diameter than the liquid argon tube, in which case the liquid nitrogen tube is generally radially outboard of the liquid argon tube. In this configuration, the openings in the liquid nitrogen tube are arranged to direct the liquid nitrogen generally radially inward.

It can be appreciated that the heat exchanger 15 of the present disclosure operates to lower the temperature of the liquid argon flowing from the bulk tank 10 to the transport tank 18. As the argon is cooled the pressure of the liquid argon within the tube arrangement 14 decreases by about 30-50 psig without any corresponding loss of liquid argon or any corresponding change of state of the liquid argon. The lower pressure of the liquid argon as it leaves the heat exchanger through the outlet tube 16 reduces, and in some cases eliminates, the losses that occur in the conventional transfer process. In the conventional process the liquid argon is maintained substantially at its bulk storage pressure, 100 psig in the present example, but must be reduced to the DOT regulated pressure of 22-25 psig within the transport tank 18. In order to achieve this significant pressure reduction it is necessary to open a relief valve in the transport tank and relieve argon gas to the atmosphere. It can be appreciated that a 75 psig differential in the conventional system can require significant venting of argon gas, leading to the 30% loss of liquid argon. However, with the system and method of the present disclosure the liquid argon enters the transport tank 18 at a much lower pressure, nominally 30-50 psig or less. The pressure differential is no longer 75 psig, but in the range of 5-25 psig. It can thus be appreciated that this much reduced pressure differential means that significantly less argon gas must be vented to achieve the DOT regulated pressure within the transport tank 18. Moreover, the liquid argon becomes more dense as it cools. The greater density allows more liquid argon to flow through the heat exchanger 15 into the transport tank 18, since the liquid level is constrained by the total volume of the internal tube arrangement 14.

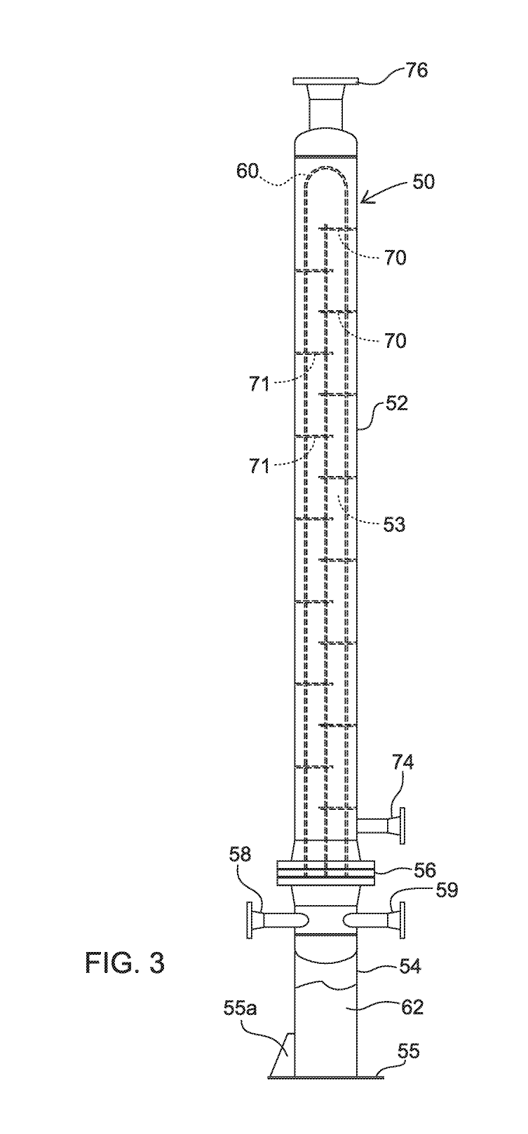

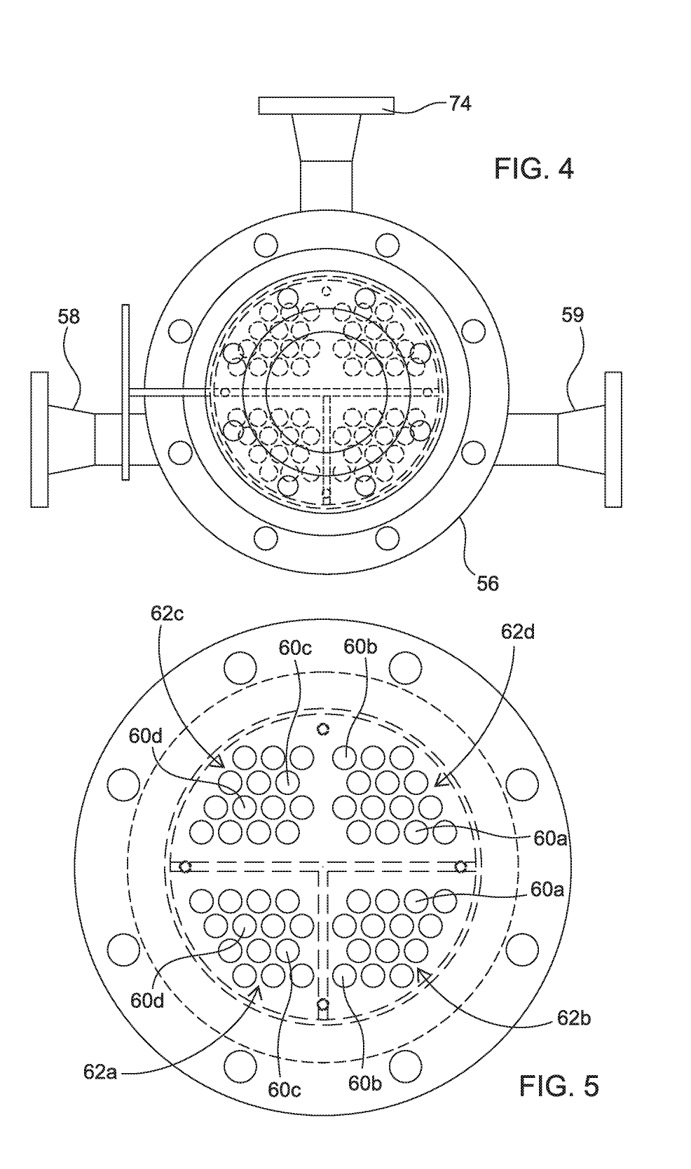

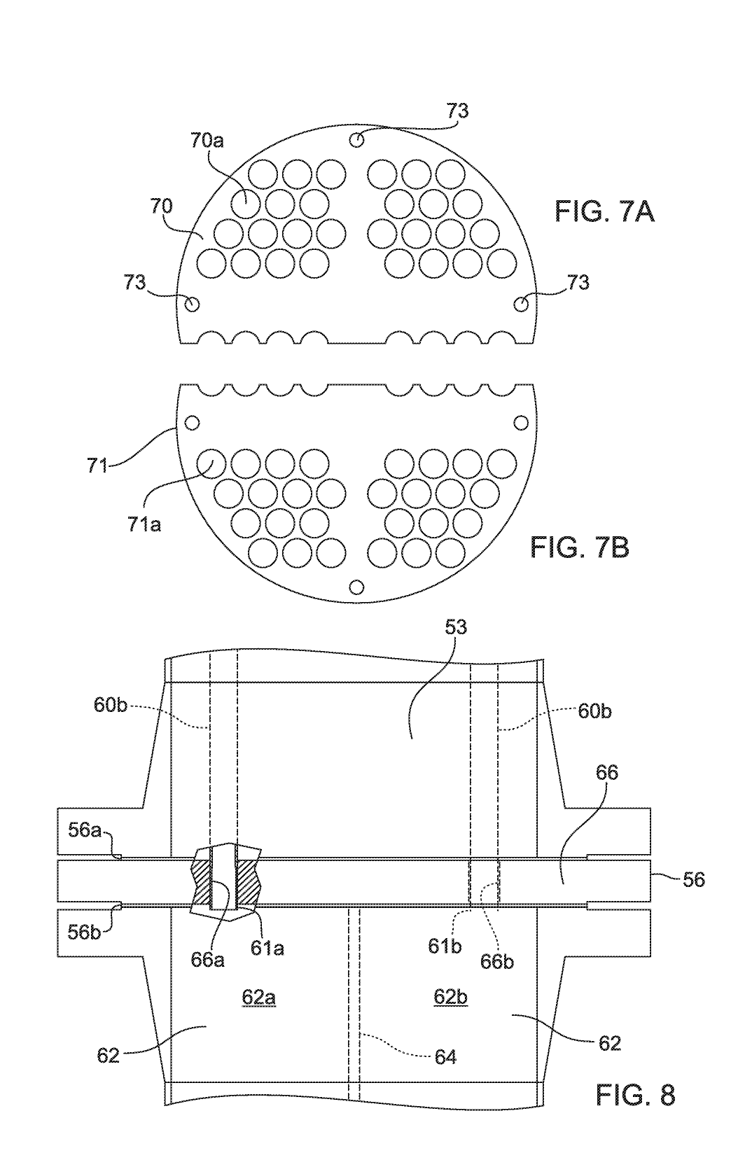

In another embodiment shown in FIGS. 3-8, a heat exchanger 50 includes a vertical tubular housing 52 supported on a skirt 54 mounted on a platform 55 and anchored with gussets 55a. The elongated tubular housing 52 defines an interior chamber 53 that is supplied with liquid nitrogen through nitrogen inlet 74. As the nitrogen ascends within vertical housing 52 I gradually changes to the gaseous state, exiting the housing at the nitrogen vapor vent 76 at the top of the housing. An arrangement of baffles 70, 71 define an upward serpentine path for the nitrogen flowing within the tubular housing 52 from the bottom of the housing to the vent 76.

The skirt 54 defines an interior chamber 62 that is separated by a baffle 64 into an inlet chamber 62a, an outlet chamber 62b and left and right intermediate chambers 62c and 62d, respectively. The inlet chamber 62a is in fluid communication with a liquid argon inlet 58, while the outlet chamber 62b is in fluid communication with a liquid argon outlet 59. The tubular housing 52 is engaged to the skirt 54 at a mounting flange 56, with the flange positioned above the argon inlet and outlet. As shown in the detail view of FIG. 8, the mounting flange 56 includes a mounting plate 66 sandwiched between the mating flange elements 56a, 56b. The mounting flange includes an appropriate gasket or seal arrangement to provide a fluid and gas tight seal between the mounting plate 66 and the skirt chamber 62, and between mounting plate and the housing chamber 53.

A shown in FIG. 8, the mounting plate 66 includes a plurality of openings, such as openings 66a, 66b, to receive and support the argon tube arrangement that includes a plurality of U-shaped tubes 60 (FIG. 3). The lower ends 61a, 61b open into the respective inlet chamber 62a and outlet chamber 62b, that in turn communicate with the respective liquid argon inlet 58 and outlet 59. The tubes 60 pass through corresponding openings 70a and 71a in respective baffles 70, 71 to support the tubes along the entire length of the tubular housing 52. A number of tie bars (not shown) can pass through openings 73 in the baffles 70, 71 and anchored at the mounting flange 56 to provide stability to the tubular housing and argon tube arrangement 60.

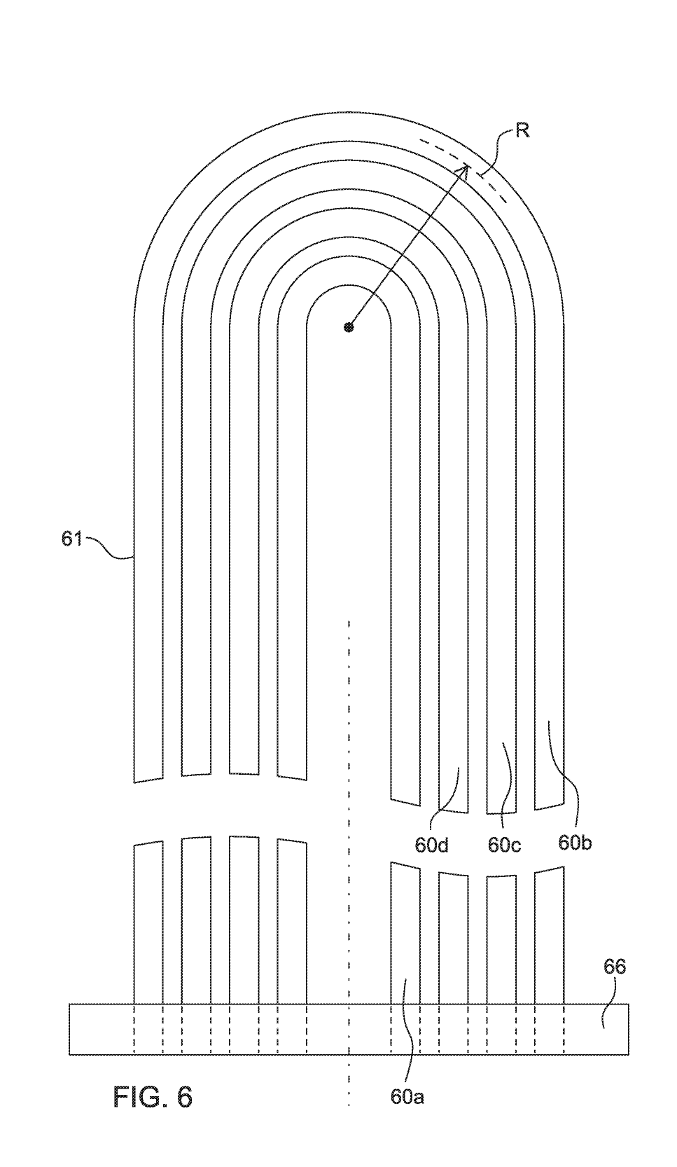

As shown in FIGS. 5 and 6, the tubes 60 are provided in a range of nested sizes, from the tubes 60a having a narrower lateral extent to the tubes 60b having a wider lateral extent. U-shaped tubes 60c and 60d are sized to nest between the narrower and wide tubes 60a, 60b. Thus, as depicted in FIG. 5, fourteen U-shaped tubes 50 can fit within the chamber 53 of the tubular housing 52. Each of the U-shaped tubes defines a bend radius R to the centerline (FIG. 6). In one specific embodiment, the bend radius can be about 0.95 in. for the smaller tube 60a, 1.6 in. for the tube 60d, 2.2 in. for the tube 60c and about 2.8 in. for the larger tube 60b. The differing bend radii allow the tubes to be arranged in a generally nested fashion, as depicted in FIG. 6. With this configuration, 28 tubes having a tube diameter of 0.625 in. can be arranged within an 8 in. diameter tubular housing 52—including six tubes at each of the larger bend radii and eight tubes at each of the smaller bend radii. The tubes 60 include generally straight legs 61 that can have a length in the specific embodiment of about 96 in. The tubular housing 52 is thus appropriately sized to encase the tubes 60. In a specific embodiment, fourteen baffles 70, 71 are provided to support the tubes within the housing. The baffles also increase the flow velocity and turbulence of the nitrogen within the housing, which increases the heat transfer rate between the argon in the tubes and the liquid nitrogen in the housing.

The liquid argon inlet 58 can be connected by way of a cryogenic pump to the liquid argon tank 10 (FIG. 1) and the argon outlet 59 can likewise be connected to the transport tank 18 in a known manner. Liquid argon is transferred (by pumping or by pressure differential) at 100 psig and −256° F. into the inlet chamber 62a and from there into each of the plurality of U-shaped tubes 60. The liquid argon is directed into the tubes at the inlet chamber 62a (FIG. 5) and then upward through the tubes to the U-shaped bend within the left intermediate chamber 62c. The argon then flows downward through the tubes to the bottom of the left intermediate chamber 62c, where the argon then passes into the U-shaped tubes in the right intermediate chamber 62d. The argon flows upward within the tubes in the intermediate chamber to the U-shaped bend, and then downward within the housing to the argon outlet 59.

The liquid nitrogen inlet 74 is connected by way of a cryogenic pump to the liquid nitrogen tank 20 and is concurrently transferred at 100 psig and −300° F. through the nitrogen interior chamber 53 of the tubular housing 52. The temperature of the nitrogen at the inlet is controlled to prevent the argon from freezing at its outlet. The baffles 70, 71 interrupt the flow of nitrogen through the chamber so that the nitrogen is maintained in contact with the U-shaped tubes 60 carrying the liquid argon. In addition, the thermodynamic characteristics of the nitrogen changes as it moves upward within the housing, so that the nitrogen is warmer at the inlet and colder at the outlet to cool the argon without it freezing at its outlet. The U-shape of the argon tubes ensures that the entire length of the tubing is contacted by the lower temperature liquid nitrogen. As with the previous embodiment, as the nitrogen changes state it draws heat energy from the argon flowing through the U-shaped tubes 60, thereby reducing the temperature and pressure, while increasing the density of the liquid argon that exits the outlet 59 into the transport tank 20. The argon can thus enter the transport tank at −300° F. and at a pressure lower than the DOT regulated pressure for transport. This translates to significant lower losses of argon to atmosphere as the transport tank is filled.

The present disclosure should be considered as illustrative and not restrictive in character. It is understood that only certain embodiments have been presented and that all changes, modifications and further applications that come within the spirit of the disclosure are desired to be protected.

What is claimed is:

1. A system for transferring liquid argon from a bulk storage tank to a transport tank comprising:
a storage tank containing liquid nitrogen; and
a heat exchanger including;
a housing defining an interior chamber;
a liquid argon tube arrangement disposed within the interior chamber and having an inlet configured for fluid communication with the bulk storage tank and an outlet configured for fluid communication with the transport tank;
a liquid nitrogen tube arrangement in fluid communication with said liquid nitrogen bulk storage tank and disposed within the interior chamber in close proximity to the liquid argon tube arrangement, the liquid nitrogen tube arrangement including a plurality of openings positioned and arranged to direct liquid nitrogen from the liquid nitrogen tube arrangement onto the liquid argon tube arrangement; and
a vent defined in the housing in communication with the interior chamber to vent gaseous nitrogen therefrom.

2. The system for transferring liquid argon of claim 1, wherein:
said inlet is incorporated into said housing at or adjacent an upper portion of the housing; and
said outlet is incorporated into said housing at or adjacent a lower portion of the housing

3. The system for transferring liquid argon of claim 1, wherein said liquid argon tube arrangement includes a first spiral tube extending from said inlet to said outlet.

4. The system for transferring liquid argon of claim 3, wherein said first spiral tube includes twenty coils between said inlet and said outlet.

5. The system for transferring liquid argon of claim 3, wherein said liquid nitrogen tube arrangement includes a second spiral tube that is substantially concentric with the first spiral tube.

6. The system for transferring liquid argon of claim 4, wherein said first spiral tube and said second spiral tube each include twenty coils.

7. The system for transferring liquid argon of claim 5, wherein said second spiral tube is configured and arranged to be radially inboard relative to said first spiral tube.

8. The system for transferring liquid argon of claim 1, wherein the nitrogen in said nitrogen storage tank is maintained at a temperature less than the temperature of the liquid argon in the bulk storage tank.

9. The system for transferring liquid argon of claim 8, wherein the nitrogen in said nitrogen storage tank is maintained at a temperature of about −280° F.

10. The system for transferring liquid argon of claim 9, wherein the nitrogen in said nitrogen storage tank is maintained at a pressure of about 100 psig.

11. A system for transferring liquid argon from a bulk storage tank to a transport tank comprising:
a storage tank containing liquid nitrogen; and
a heat exchanger including an elongated tubular housing defining an interior chamber;
a liquid argon tube arrangement disposed within the interior chamber and having an inlet configured for fluid communication with the bulk storage tank and an outlet configured for fluid communication with the transport tank;
a liquid nitrogen inlet in fluid communication with said liquid nitrogen storage tank and opening to the interior chamber adjacent the bottom of the tubular housing; and
an outlet for venting nitrogen vapor from the interior chamber at the top of the elongated tubular housing.

12. The system for transferring liquid argon of claim 11, wherein said liquid nitrogen inlet includes a spray nozzle directed toward said interior chamber to spray liquid nitrogen onto said liquid argon tube arrangement.

13. The system for transferring liquid argon of claim 11, wherein:
said inlet is incorporated into said housing at or adjacent an upper portion of the housing; and
said outlet is incorporated into said housing at or adjacent a lower portion of the housing

14. The system for transferring liquid argon of claim 11, wherein said liquid argon tube arrangement includes a spiral tube extending from said inlet to said outlet.

15. The system for transferring liquid argon of claim 14, wherein said first spiral tube includes twenty coils between said inlet and said outlet.

16. The system for transferring liquid argon of claim 11, wherein said liquid argon tube arrangement includes a plurality of U-shaped tubes, each of said tubes including a U-shaped bend at one end and two elongated legs each having an opening at the opposite end of the U-shaped tube, with the opening at one of the elongated legs in communication with said inlet and the opening at the other of the elongated legs in communication with said outlet.

17. The system for transferring liquid argon of claim 16, wherein said two elongate legs of each of said U-shaped tubes has a length of 96 in.

18. The system for transferring liquid argon of claim 16, wherein said plurality of U-shaped tubes includes several tubes having a different bend radius.

19. The system for transferring liquid argon of claim 16, wherein said plurality of U-shaped tubes includes twenty-eight (28) tubes.

20. The system for transferring liquid argon of claim 16, wherein said housing includes a plurality of baffles distributed along the length of said tubular housing and configured to support said plurality of U-shaped tubes within said housing.

21. The system for transferring liquid argon of claim 20, wherein said plurality of baffles are distributed along the length of said tubular housing to define a serpentine flow path for liquid nitrogen flowing from the bottom of the housing to the vent.

22. The system for transferring liquid argon of claim 16, further comprising:
a skirt supporting said tubular housing, said skirt defining an interior chamber separated by a baffle into an inlet chamber and an outlet chamber, said skirt incorporating said inlet in fluid communication with said inlet chamber and incorporating said outlet in fluid communication with said outlet chamber; and
a support plate between said skirt and said tubular housing, wherein said support plate supports each of said plurality of U-shaped tubes with opening of said one leg of each of said tubes in fluid communication with said inlet chamber and the opening of said other leg of each of said tubes in fluid communication with said outlet chamber.

23. The system for transferring liquid argon of claim 11, wherein the nitrogen in said nitrogen storage tank is maintained at a temperature less than the temperature of the liquid argon in the bulk storage tank.

24. The system for transferring liquid argon of claim 23, wherein the nitrogen in said nitrogen storage tank is maintained at a temperature of about −280° F.

25. The system for transferring liquid argon of claim 24, wherein the nitrogen in said nitrogen storage tank is maintained at a pressure of about 100 psig.

26. A method for transferring liquid argon from a bulk storage tank to a transport tank comprising:
pumping liquid argon at a first temperature and first pressure through a tubing arrangement within a housing;
contacting the tubing arrangement with liquid nitrogen within the housing, the liquid nitrogen at a second temperature lower than said first temperature so that heat energy is transferred from the liquid argon to the liquid nitrogen, whereby the temperature and pressure of the liquid argon is reduced and the liquid nitrogen changes to a gaseous state;
discharging the liquid argon to the transport tank at the lower temperature and pressure; and
venting the gaseous nitrogen from the housing.

27. The method according of claim 26, wherein the first temperature of the liquid argon is −256° F. and the second temperature of the liquid nitrogen is −280° F.

28. The method according to claim 26, wherein the first pressure of the liquid argon is between 50-250 psig and the reduced pressure of the liquid argon is between 5-50 psig.
